(19) United States
(12) Patent Application Publication
(10) Pub. No.: US 2005/0078831 A1
(43) Pub. Date: Apr. 14, 2005

(54) Circuit and method for enhancing a stereo signal

(76) Inventors: Roy Irwan, Eindhoven (NL); Ronaldus Maria Aarts, Eindhoven (NL)

Correspondence Address: Philips Electronics North America Corporation;Corporate Patent Counsel, PO Box 3001, Briarcliff Manor, NY, 10510, US

(21) Appl. No.: 10/497,340

(22) PCT Filed: Nov. 20, 2002
(86) PCT No.: PCT/IB02/04927

(30) Foreign Application Priority Data
Dec. 5, 2001 (EP) 01204679.3

(51) Int. Cl. H04R 5/00

(52) U.S. Cl. 381/1; 381/17

(57) ABSTRACT

The invention relates to a circuit (100) for enhancing a stereo sound signal, represented by a left input signal (L) and a right signal (R). By only using the parts of the left input signal (L) and the right input signal (R) that are not correlated to each other, unwanted stereo enhancement of, for example, dialogs is eliminated. On the other hand, the stereo image of sound effects like explosions will be enhanced. Most movies are properly mixed for this. In one embodiment of the invention, a center signal is generated by averaging the left input signal and the right input signal. The invention relates to a method of enhancing a stereo sound signal. The invention also relates to an apparatus (500) for reproducing sound. The invention further relates to a record carrier (610) comprising a computer-executable code, enabling a computer (620) to perform the method according to the invention

The invention relates to a circuit adapted to enhance a stereo signal comprising a left input signal and a right input signal.

The invention also relates to a method of enhancing a stereo sound signal comprising a left input signal and a right input signal.

The invention also relates to an apparatus for reproducing audio data.

The invention further relates to a record carrier comprising instructions which can be executed by a processor.

Such a circuit is known from EP 0 664 661 A1. The disclosed circuit generates an enhanced stereo signal if the left input signal and the right input signal are not equal.

The circuit described in EP 0 664 661 A1 has the drawback that it also enhances the stereo signal if the phases of the left input signal and the right input signal are equal but differ in amplitude. If the stereo signal comprises a dialog in which the phases of the left input signal and the right input signal are equal but the amplitudes of both signals differ, the stereo image of the dialog is enhanced by the circuit disclosed in EP 0 664 661. Users experience this as an unpleasant aspect.

It is an object of the invention to mitigate said drawbacks of the prior art.

According to the invention, this object is achieved with the circuit which is characterized in that it comprises means for computing a cross-correlation between the left input signal and the right input signal, means for generating an enhanced stereo signal comprising an enhanced left signal and an enhanced right signal on the basis of the cross-correlation, in which the enhanced stereo signal is stronger as the cross-correlation is smaller, first adding means for adding the left input signal and the enhanced left signal together so as to obtain a left output signal, and second adding means for adding the right input signal and the enhanced right signal together so as to obtain a right output signal.

This has the advantage that the stereo signal is only enhanced if the left input signal and the right input signal have a small (cross-)correlation.

An embodiment of the circuit according to the invention is characterized in that the circuit is further adapted to subtract the right input signal and the left input signal from each other so as to obtain a differential signal, generate the enhanced left signal, dependent on the cross-correlation and the differential signal, and generate the enhanced right signal, dependent on the cross-correlation and the differential signal.

This has the advantage that the effect of broadening the stereo signal—an effect of enhancing the stereo signal—becomes stronger if the left input signal and the right output signal differ to a maximum extent. This yields an extra spatial sound effect for a user of the system.

An embodiment of the circuit according to the invention is characterized in that the circuit is further adapted to generate a right output signal, which is the sum of the right input signal and the enhanced right signal, and to generate a left output signal, which is the sum of the right input signal and the enhanced left signal.

A further embodiment of the circuit according to the invention is characterized in that the circuit is further adapted to scale the right input signal and the enhanced right signal with respect to each other and scale the left input signal and the enhanced left signal with respect to each other.

This has the advantage that a user of the circuit can determine the enhancement of the stereo signal in accordance with his or her own preference.

A further embodiment of the circuit according to the invention is characterized in that the circuit is further adapted to take the average of the left input signal and the right input signal so as to form a center signal.

This has the advantage that the circuit directly computes the center signal in a simple way from signals which are already available.

The apparatus according to the invention is characterized in that the apparatus comprises the circuit as defined in claim 1.

The method according to the invention is characterized in that the method comprises the steps of computing a cross-correlation between the left input signal and the right input signal, generating an enhanced right signal, which is dependent on the cross-correlation, and generating an enhanced left signal, which is dependent on the cross-correlation.

The record carrier according to the invention is characterized in that the instructions enable the processor to perform the method as defined in claim 8.

These and other aspects of the invention are apparent from and will be elucidated with reference to the embodiments described hereinafter.

In the drawings:

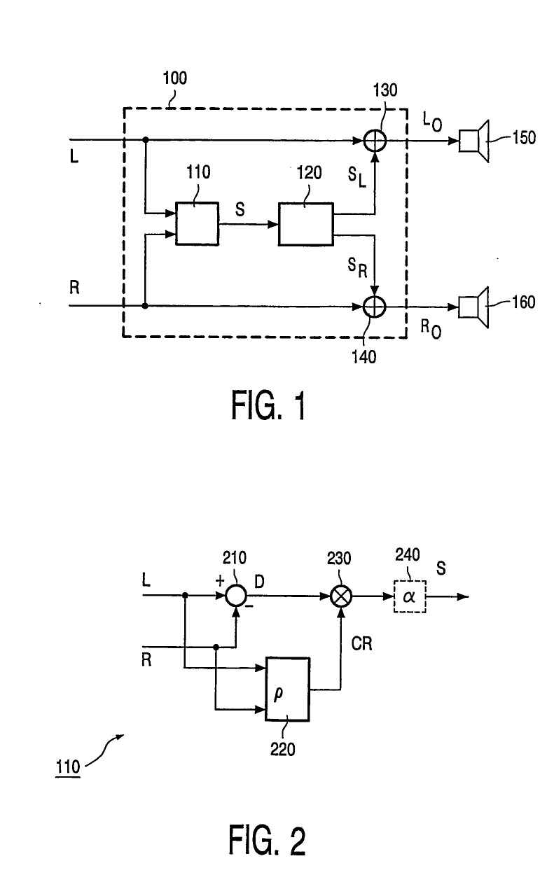

FIG. 1 is a block diagram of a first circuit as an embodiment of the invention,

FIG. 2 is a block diagram of correlation means for use in a circuit according to the invention,

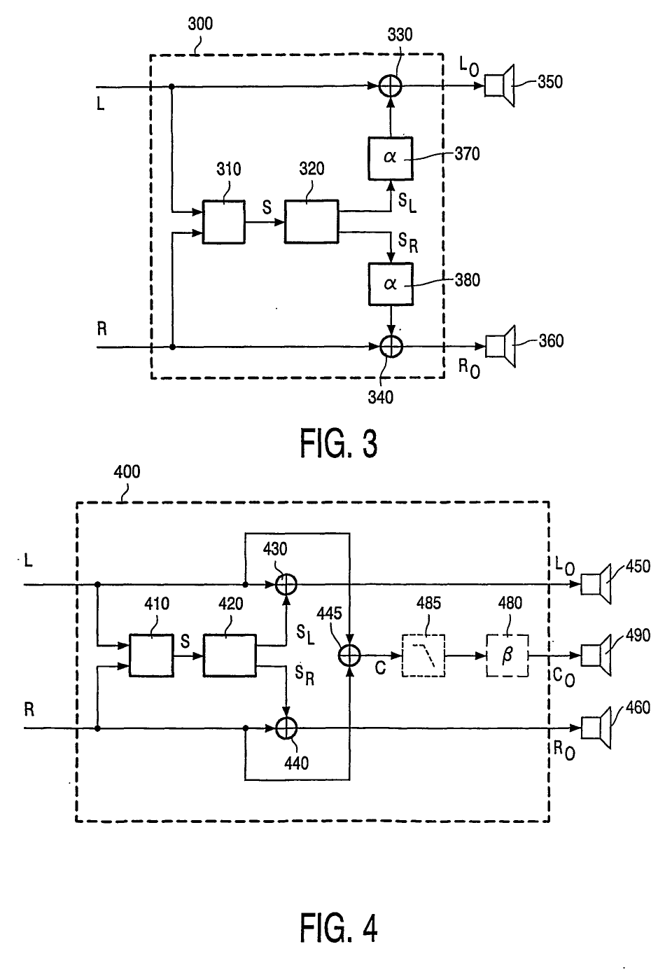

FIG. 3 is a block diagram of a second circuit as an embodiment of the invention,

FIG. 4 is a block diagram of a third circuit as an embodiment of the invention,

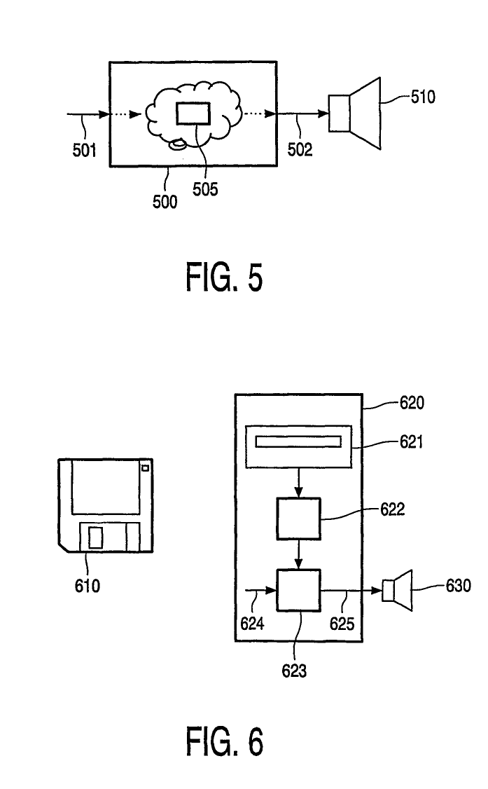

FIG. 5 is an apparatus according to the invention,

FIG. 6 shows an embodiment of the record carrier according to the invention.

FIG. 1 shows a circuit 100 as an embodiment of the invention. The circuit 100 comprises correlation means 110, surround signal processing means 120, first adding means 130 and second adding means 140. FIG. 1 also shows a left loudspeaker 150 and a right loudspeaker 160. The left loudspeaker 150 is connected to the left output of the circuit 100 and the right loudspeaker 160 is connected to the right output of the circuit 100.

A left input signal L and a right input signal R are applied to the circuit 100. The left input signal L and the right input signal R are applied to the correlation means 110. The correlation means 110 generate a surround signal which is related to the cross-correlation of the left input signal L and the right input signal R. In a preferred embodiment of the invention, it holds that the surround signal S has a minimum value if the left input signal L and the right input signal R are completely correlated (the correlation coefficient is 1). If the correlation coefficient of both signals is 0, the surround signal S has a maximum value in the same preferred embodiment of the invention.

The surround signal S is applied to the surround signal processor 120. Such a surround signal processor is known per se from WO 99/41947. The surround signal processor of this document converts a surround signal into two further surround signals so as to place virtual sound sources next to the left and right speaker. The further surround signals are created by splitting the surround signal by means of a filter. This filter splits at least a selected frequency band of the surround signal into two signals having mainly disjunct frequency bands. The disjunct frequency bands are complementary and jointly constitute the selected frequency band of the surround signal. One of the further surround signals is combined with a left signal, for example, by addition, and the other further surround signal is combined with a right signal. The combined signals are applied to a left and a right speaker for reproduction. The contents of WO 99/41947 are herein incorporated by reference.

The surround signal processor 120 generates an enhanced left signal S_{L} and an enhanced right signal S_{R} on the basis of the surround signal S. In a preferred embodiment of the invention as shown in FIG. 1, the enhanced left signal S_{L} is added to the left input signal L by the first adding means 130, and the enhanced right signal S_{R} is added to the right input signal R by the second adding means 140. In this way, a left output signal L_{O} and a right output signal R_{O} are generated. In the embodiment shown, the left output signal is directly applied to a left loudspeaker 150 and the right output signal is directly applied to a right loudspeaker 160. The output signals of the circuit 100 may be further processed, which, of course does not detract from the scope of the invention. An example of further processing is amplification or bass enhancement.

FIG. 2 shows an embodiment of the correlation means 110. In the presented embodiment of the correlation means, the left input signal L and the right input signal R are subtracted from each other by subtracting means 210 so as to form a differential signal D. The left input signal L and the right input signal R are also applied to a correlation unit 220. The correlation unit 220 computes the cross-correlation between the left input signal L and the right input signal R. This is preferably effected in a “gliding” interval which is known per se. The cross-correlation may be alternatively computed in disjunct time intervals, which does not detract from the scope of the invention.

The output of the correlation unit 220 is a signal CR having a value which is proportional to the correlation coefficient of the two input signals. The differential signal D and the correlation signal CR are multiplied by each other in multiplying means 230 so as to form the surround signal S. The relation between the input signal and the surround signal S can be preferably represented in the way shown in relation (1). In relation (1), ρ is the correlation coefficient between the left input signal L and the right input signal R and α is an optional scalar. Multiplication by the scalar α may be effected by amplification means 240 in the embodiment shown. The scalar α preferably has a nominal value of ½√2.
S=α(1−ρ)(L−R), αε+ [symbol] ⁺ (1)

FIG. 3 shows a circuit 300 as a further embodiment of the invention. The circuit 300 comprises correlation means 310, surround signal processing means 320, first adding means 330 and second adding means 340. FIG. 3 also shows a left loudspeaker 350 and a right loudspeaker 360. The left loudspeaker 350 is connected to the left output of the circuit 300 and the right loudspeaker 360 is connected to the right output of the circuit 300. Circuit 300 also comprises first amplifying means 370 and second amplifying means 380.

The operation of the circuit 300 is mainly the same as that of the circuit 100 (FIG. 1). The difference is that the enhanced left signal S_{L} and the enhanced right signal S_{R} can be scaled by a factor α before they are added to the left input signal and the right input signal, respectively. It will be evident to those skilled in the art that the factor α may also be larger than 1 in order that the enhanced signals are amplified before they are added to the input signals. In one embodiment of the invention, the amplification factor α is adjustable. The adjustment may be done by a user but also by a further device. It will be evident to those skilled in the art that, in a further embodiment of the invention, the left input signal L can be scaled with respect to the enhanced left signal S_{L} and the right input signal R can be scaled with respect to the enhanced right signal S_{R}.

FIG. 4 shows a circuit 400 as a further embodiment of the invention. The circuit 400 comprises correlation means 410 for computing the cross-correlation between two signals, surround signal processing means 420, first adding means 430 and second adding means 440. FIG. 4 also shows a left loudspeaker 450 and a right loudspeaker 460. The left loudspeaker is connected to a left output of the circuit 400 and the right loudspeaker is connected to a right output of the circuit 400.

The operation of the circuit 400 is mainly the same as that of the circuit 100 (FIG. 1). The circuit 400 also comprises third adding means 445 adapted to add the left input signal L and the right input signal R together so as to form a center signal C. The center signal C is outputted from the circuit 400 as a center output signal C_{O} which is applied to a central loudspeaker 490.

In a further embodiment of the invention, the center signal is further processed before it is outputted from the circuit 400. The circuit 400 comprises an optional low-pass filter 485 for removing all signal components having a frequency of more than 200 Hz from the center signal. Since low signal components give little directional information when they are reproduced by a loudspeaker, this does not detract from the quality of the enhancement of the input signals. In this embodiment, the center output signal C_{O} may be applied to a sub-woofer speaker.

The circuit 400 is also provided with amplifying means 480 having an amplification factor β for scaling the center signal C with respect to the left output signal L_{O} and the right output signal R_{O}. It will be evident to those skilled in the art that the amplification factor β may also be smaller than 1 so that the center signal C is attenuated. By generating the center signal C by adding the left input signal L and the right input signal R together, the center signal C will generally be a factor of ✓2 larger than would be natural to a listener. For this reason, the amplification factor β is preferably equal to ½✓2.

It will be evident to those skilled in the art that the circuit according to the invention may be both digital and analog.

FIG. 5 shows an apparatus 500 for reproducing audio signals as an embodiment of the invention. The apparatus comprises input means 501, output means 502 and a circuit 505 as an embodiment of the invention. Possible embodiments of the input means may be RF antenna, SACD, DVD, CD, CD-ROM with, for example, MP3 files, tape cassettes, vinyl records or an output signal of the apparatus 500, electric or optical, adapted to convert information on a record carrier into an optical or electric signal. However, this number of means is not limitative as will be evident to those skilled in the art. Possible embodiments of the output means are a CD burner, an electric signal or an RF signal. As will be evident to those skilled in the art, neither this number of means is limitative.

If the output means 502 present an electric signal, they can be coupled to a loudspeaker 510. Those skilled in the art will understand that this may also be a group of loudspeakers if the apparatus 505 is, for example, a 5-channel surround sound system.

FIG. 6 shows a diskette 610 as an embodiment of a record carrier according to the invention, comprising instructions which can be executed by a processor and enable it to perform the method according to the invention. The record carrier 610 may be used in a computer 620. This may be a personal computer but also, for example, a Personal Digital Assistant or a UNIX workstation. The computer 620 comprises a diskette station 621 which is connected to a processor 622. The processor 622 is further connected to a signal processing circuit 623 having an input 624 and an output 625. The diskette station 621 is adapted to read information from the diskette 610 and pass it on to the processor 622. The information comprises instructions which can be executed by the processor 622 and enable the processor 622 to process an input signal at the input 624 of the signal-processing circuit 623 via the signal-processing circuit 623 by means of the method according to the invention. The processed signal is subsequently passed on for reproduction via the output 625 of the signal-processing circuit 623 to a loudspeaker 630.

In the presented embodiment, the record carrier according to the invention is a diskette 610. However, the record carrier 610 may be alternatively a CD-ROM or a flash card but also a mass storage device which is coupled to a WAN such as the Internet. A different embodiment of the record carrier according to the invention is, however, also possible and does not detract from the scope of the invention.

In summary, the invention relates to a circuit (100) for enhancing a stereo sound signal, represented by a left input signal (L) and a right input signal (R). By only using the parts of the left input signal (L) and the right input signal (R) that are not correlated to each other, unwanted stereo enhancement of, for example, dialogs is eliminated. On the other hand, the stereo image of sound effects like explosions will be enhanced. Most movies are properly mixed for this. In one embodiment of the invention, a center signal is generated by averaging the left input signal and the right input signal. The invention relates to a method of enhancing a stereo sound signal. The invention also relates to an apparatus (500) for reproducing sound. The invention further relates to a record carrier (610) comprising a computer-executable code, enabling a computer (620) to perform the method according to the invention.

1. A circuit (100) adapted to enhance a stereo signal comprising a left input signal (L) and a right input signal (R), characterized in that the circuit comprises:
means (110) for computing a cross-correlation (CR) between the left input signal (L) and the right input signal (R);
means (120) for generating an enhanced stereo signal comprising an enhanced left signal (S_{L}) and an enhanced right signal (S_{R}) on the basis of the cross-correlation (CR), in which the enhanced stereo signal is stronger as the cross-correlation (CR) is smaller,
first adding means (130) for adding the left input signal (L) and the enhanced left signal (S_{L}) together so as to obtain a left output signal (L_{O}), and
second adding means (140) for adding the right input signal (R) and the enhanced right signal (S_{R}) together so as to obtain a right output signal (R_{O}).

2. A circuit (100) as claimed in claim 1, characterized in that the circuit is further adapted to
subtract the right input signal (R) and the left input signal (L) from each other so as to obtain a differential signal (D),
generate the enhanced left signal (S_{L}), dependent on the cross-correlation (CR) and the differential signal (D), and
generate the enhanced right signal (S_{R}), dependent on the cross-correlation (CR) and the differential signal (D).

3. A circuit as claimed in claim 1, characterized in that the circuit (300) is further adapted to
scale the right input signal (R) and the enhanced right signal (S_{R}) with respect to each other before adding them together, and
scale the left input signal (L) and the enhanced left signal (S_{L}) with respect to each other before adding them together.

4. A circuit as claimed in claim 1, characterized in that the circuit (400) is further adapted to take the average of the left input signal (L) and the right input signal (R) so as to form a center signal (C).

5. A circuit as claimed in claim 1, characterized in that the circuit (400) is further adapted to take the average of the enhanced left signal (S_{L}) and the enhanced right signal (S_{R}) so as to form a center signal (C).

6. A circuit as claimed in claim 4, characterized in that the circuit further comprises a filter (480), which filter (480) is adapted to filter the center signal (C) in such a way that higher frequency components are removed from the center signal (C).

7. A method of enhancing a stereo signal comprising a left input signal (L) and a right input signal (R), characterized in that the method comprises the steps of:
computing a cross-correlation (CR) between the left input signal (L) and the right input signal (R),
generating an enhanced stereo signal comprising an enhanced left signal (S_{L}) and an enhanced right signal (S_{R}), in which the enhanced stereo signal is stronger as the cross-correlation (CR) is smaller,
adding the left input signal (L) and the enhanced left signal (S_{L}) so as to obtain a left output signal (L_{O}),
adding the right input signal (R) and the enhanced right signal (S_{R}) so as to obtain a right output signal (R_{O}).

8. An apparatus (500) for reproducing audio data, characterized in that the apparatus (500) comprises the circuit as claimed in claim 1.

9. A record carrier (610) comprising instructions which can be executed by a processor (622), characterized in that the instructions enable the processor (622) to perform the method as claimed in claim 7.
